(19) United States
(12) Patent Application Publication
(10) Pub. No.: US 2026/0322610 A1
(43) Pub. Date: Oct. 15, 2026

(54) Privacy Preserving Behavioral Prediction Engine with Federated Cyclehit Scoring, Enclave Bound History Values, Zero Knowledge Compliance Proofs, and IPS Conditioned Compute Monetization

(71) Applicant: Dario Chang, Doral, FL (US)

(72) Inventor: Dario Chang, Doral, FL (US)

(21) Appl. No.: 19/632,332

(22) Filed: Mar. 29, 2026

(51) Int. Cl. H04L 9/32; G06N 20/00; H04L 9/00

(52) U.S. Cl. CPC H04L 9/3221; G06N 20/00; H04L 9/3234; H04L 9/50

(57) ABSTRACT

A privacy-preserving behavioral prediction engine enables compliant personalization and verifiable compute monetization across cloud, edge, and GPU-accelerated environments. Behavioral signals are computed locally using federated cyclehit scoring executed inside trusted execution environments (TEEs), producing enclave-bound history values that never expose raw user data. Zero-knowledge proofs verify the correctness of local scoring, model updates, and inference execution, while secure aggregation combines encrypted updates without revealing behavioral information. A compute-value attribution module fuses behavioral importance scores with GPU telemetry, sustainability metrics, and inference-integrity proofs to generate IPS-conditioned compute value scores used for dynamic pricing, routing, and SLA enforcement. A monetization layer issues verifiable IPS tokens encoding provenance, compliance, and compute value, enabling revenue sharing and settlement across AI marketplaces. The architecture provides a unified, regulator-aligned foundation for privacy-safe behavioral prediction, verifiable inference, and sustainable compute orchestration in next-generation AI ecosystems.

### CROSS-REFERENCE TO RELATED APPLICATIONS

This application is a Continuation-in-Part of U.S. patent application Ser. No. 10/605,894 (filed Nov. 4, 2003), U.S. patent application Ser. No. 19/291,647 (filed Aug. 28, 2025), U.S. patent application Ser. No. 19/390,733 (filed Nov. 17, 2025), U.S. patent application Ser. No. 19/402,118 (filed Dec. 2025), and U.S. patent application Ser. No. 19/412,556 each of which is incorporated herein by reference in its entirety.

The 2003 parent application provides support for Cycle Hits, Hits History, rotation groups, and machine-state transitions. The present application introduces new matter relating to privacy-preserving behavioral prediction, federated cyclehit scoring, enclave-bound history scoring, zero-knowledge compliance proofs, compute-value attribution, inference-integrity verification, sustainability-aware compute placement, and GPU-aware behavioral scoring.

### FIELD OF THE INVENTION

The invention relates to artificial intelligence, privacy-preserving behavioral modeling, federated learning, cryptographic compliance proofs, compute monetization, inference integrity, and sustainability-aware compute allocation. More specifically, the invention provides a privacy-preserving behavioral prediction engine that replaces traditional behavioral tracking with federated cyclehit scoring, enclave-bound history values, and zero-knowledge proofs, enabling compliant personalization and monetizable inference across cloud, edge, GPU-accelerated, and future compute environments.

### BACKGROUND OF THE INVENTION

Existing behavioral tracking systems rely on centralized logging, cross-site tracking, opaque profiling, and raw data aggregation. These systems violate privacy regulations and lack verifiable compliance.

Existing AI inference platforms lack:
(a) privacy-preserving behavioral scoring;
(b) federated learning with secure aggregation;
(c) enclave-bound computation;
(d) zero-knowledge proofs of compliance;
(e) inference-integrity proofs;
(f) compute-value attribution for GPU pricing;
(g) sustainability-aware compute placement;
(h) GPU-aware behavioral scoring;
(i) IPS-conditioned revenue sharing.

There is a need for a unified system that computes behavioral signals locally, transmits only encrypted updates, proves compliance via zero-knowledge proofs, binds scoring to explicit consent, verifies inference integrity, and enables monetizable compute pricing across heterogeneous compute substrates.

### SUMMARY OF THE INVENTION

The invention provides a privacy-preserving behavioral prediction engine comprising:
On-Device Cyclehit Scoring Module
Federated History Scoring Module
Zero-Knowledge Compliance Layer
Trusted Execution Environment (TEE) Anchor
Consent Ledger
IPS Token Generator
Inference-Integrity Proof Module
Compute-Value Attribution Module
IPS-CVS Fusion Module
Sustainability-Aware Compute Placement Module
GPU-Aware Behavioral Scoring Module
IPS-Conditioned Revenue Sharing Module
Behavior-Safe Reinforcement Learning Module
Regulator-Auditable Proof Registry
Monetization Layer for AI Inference

The system replaces invasive behavioral tracking with provable, privacy-preserving behavioral prediction suitable for regulated environments, enterprise AI systems, and GPU-accelerated compute ecosystems.

### DETAILED DESCRIPTION OF THE INVENTION

### 1. On-Device Cyclehit Scoring Module

The module computes cyclehits locally using hashed behavioral events.

Raw events are canonicalized, hashed, stored ephemerally, and never transmitted.

Cyclehit scoring uses periodic kernels, exponential decay, contextual metadata, and user-verified outcomes.

The module outputs a cyclehit digest, confidence score, timestamp, and consent reference.

### 2. Federated History Scoring Module

History scoring is computed via secure aggregation, encrypted updates, and differential privacy.

A stratified memory fabric stores ephemeral, situational, and long-term memory.

History score values combine cyclehit digests, contextual metadata, and time-weighted influence.

No raw behavioral logs are stored centrally.

### 3. Zero-Knowledge Compliance Layer

The system generates zero-knowledge proofs (ZKPs) proving that:
(a) cyclehits were computed locally;
(b) no raw data left the device;
(c) consent was valid;
(d) scoring rules were followed.

Proof artifacts include proof_digest, proof_type, timestamp, and issuer_signature.

A Verifier API enables regulators to verify compliance without accessing personal data.

### 4. Trusted Execution Environment (TEE) Anchor

Sensitive computations occur inside a TEE.

The TEE produces attestation tokens containing enclave measurement, ips_token_digest, timestamp, and signature.

Attestation tokens are stored in a tamper-evident ledger.

### 5. Consent Ledger

Each behavioral signal references a consent artifact containing consent_id, timestamp, scope, and revocation status.

Consent revocation halts scoring and invalidates IPS tokens.

### 6. Ips Token Generator

IPS tokens include ips_value, ips_version, cyclehit_digest, history_digest, proof_digest, attestation_digest, and consent_reference.

IPS tokens contain no personal data.

IPS tokens condition personalization, routing, pricing, and compliance gating.

### 7. Inference-Integrity Proof Module

The module generates proofs that an inference was executed correctly on a specified hardware platform.

Proofs include:
(a) ZKP inference proofs;
(b) TEE-verified inference execution;
(c) inference receipts;
(d) model-version binding;
(e) latency and throughput attestations.

Inference proofs are referenced by IPS tokens.

### 8. Compute-Value Attribution Module

The module computes a Compute Value Score (CVS) combining:
(a) IPS;
(b) GPU telemetry;
(c) latency;
(d) throughput;
(e) memory pressure;
(f) sustainability metrics.

CVS conditions GPU pricing, NIM routing, inference SLAs, and revenue sharing.

### 9. IPS-CVS Fusion Module (New Matter)

IPS and CVS may be fused using weighted, learned, or rule-based operators to produce a Joint Compute Value Score (JCVS).

JCVS conditions compute allocation, GPU pricing, inference routing, and monetization flows.

### 10. Sustainability-Aware Compute Placement Module

The module ingests carbon-intensity metrics and adjusts compute placement.

IPS, CVS, or JCVS may incorporate sustainability penalties or incentives.

Workloads are routed to greener nodes when IPS deltas are within tolerance.

### 11. Gpu-Aware Behavioral Scoring Module

Federated cyclehit scoring may incorporate GPU-level telemetry including queue depth, region latency, compute scarcity, and thermal constraints.

Behavioral scoring may be adjusted based on GPU availability and sustainability metrics.

### 12. IPS-Conditioned Revenue Sharing Module

IPS tokens may encode monetization parameters including revenue-share percentages, licensing tiers, and settlement conditions.

IPS-conditioned revenue sharing applies to inference marketplaces, compute markets, and agentic compute ecosystems.

### 13. Behavior-safe Reinforcement Learning Module

Reinforcement learning agents may consume IPS tokens as state inputs, enabling policy optimization without access to raw behavioral data.

IPS-conditioned RL ensures privacy-safe personalization and compute allocation.

### 14. Proof Registry

The registry stores ZKPs, attestation tokens, consent proofs, inference proofs, IPS digests, and JCVS digests.

Regulators can verify compliance without accessing personal data.

### 15. Monetization Layer

IPS, CVS, and JCVS condition inference pricing, model selection, compute allocation, SLA enforcement, and revenue sharing.

The system integrates with cloud providers including NVIDIA and AWS.

### EXPANSION MODULES (FUTURE CIP SUPPORT)

Quantum-assisted IPS fusion.

Neuromorphic behavioral scoring.

Multi-agent negotiation for compute markets.

Post-quantum inference proofs.

Synthetic-data attestation.

Fraud-graph fusion.

Multimodal provenance (audio, video, sensor, LLM outputs).

Federated settlement layer.

ESG-anchored compute credits.

The modules, scoring mechanisms, proof systems, and monetization flows described herein are not limited to any particular hardware, software, or execution environment. The invention applies equally to current and future compute substrates, including but not limited to: cloud GPUs, edge accelerators, neuromorphic processors, quantum-assisted inference engines, distributed agentic compute networks, sovereign AI clusters, AI factories, federated compute fabrics, and any environment capable of executing behavioral scoring, inference verification, or compute-value attribution.

References to specific technologies, hardware types, cryptographic primitives, or compute environments are exemplary and non-limiting. The invention encompasses all variations, substitutions, and equivalents that achieve the described behavioral prediction, compliance verification, inference integrity, or compute monetization functions, regardless of the underlying implementation.

The invention provides a unified, privacy-preserving behavioral prediction engine integrating federated scoring, ZKP proofs, TEE attestation, consent enforcement, inference-integrity verification, compute-value attribution, sustainability-aware compute placement, GPU-aware behavioral scoring, and IPS-conditioned monetization.

The architecture is designed for enterprise AI, regulated environments, and GPU-accelerated compute ecosystems such as NVIDIA's AI Factory.

### Tokenization of Model and Audit Artifacts (New Matter)

In some embodiments, intellectual property rights associated with behavioral scoring models, audit logs, or compliance artifacts may be tokenized as non-fungible tokens (NFTs) or equivalent digital assets. Such tokens may encode ownership, licensing rights, fractional interests, or settlement conditions, and may be transferred or traded via smart contracts or programmable settlement rails.

### Physically Unclonable Function (PUF) Root of Trust

In some embodiments, the trusted execution environment may incorporate a physically unclonable function (PUF) as a hardware root of trust. The PUF may generate device-unique cryptographic keys used to sign attestation reports, bind enclave-bound history values, authenticate model updates, or verify the integrity of inference-integrity proofs.

### Telemetry Standards and Instrumentation

Compute-value attribution may utilize standardized telemetry frameworks, including but not limited to OpenTelemetry, for capturing fine-grained compute usage, model execution traces, agent decisions, and outcome metrics. Telemetry data may be cryptographically bound to IPS, CVS, or JCVS tokens to ensure verifiable attribution and auditability.

### Universal Applicability Clause

The systems and methods described herein are not limited to any particular hardware, software, or execution environment. The invention applies to current and future compute substrates, including cloud GPUs, edge accelerators, neuromorphic processors, quantum inference engines, sovereign AI clusters, agentic compute networks, and any environment capable of executing behavioral scoring, inference verification, or compute-value attribution. All embodiments are intended to cover technological equivalents and future architectures performing substantially the same functions.

### Functional Equivalence Clause

References to specific technologies, hardware types, cryptographic primitives, or compute environments are exemplary and non-limiting. The invention encompasses all functional equivalents that perform substantially the same behavioral scoring, compliance verification, inference integrity, compute-value attribution, or monetization functions, regardless of the underlying algorithmic, cryptographic, or hardware implementation.

1. A privacy-preserving behavioral prediction system comprising: a plurality of client devices, each configured to locally collect behavioral data and execute a behavioral scoring model within a trusted execution environment (TEE) to generate enclave-bound history values; a federated learning coordinator configured to orchestrate training of the behavioral scoring model across the client devices using federated cyclehit scoring, wherein each client device generates a zero-knowledge proof attesting to compliance with a prescribed training protocol and the integrity of local model updates; a secure aggregation module configured to aggregate verified model updates from selected clients without accessing raw behavioral data; an audit log subsystem configured to immutably record enclave-bound history values, model update attestations, and compliance proofs in a tamper-evident log; a compute-value attribution engine configured to meter and attribute compute resources consumed by each client device and federated round; and a monetization module configured to issue or redeem IPS tokens to client devices or compute providers based on attributed compute value and compliance with sustainability-aware compute placement policies.

2. A method for privacy-preserving behavioral prediction and compute monetization, comprising: collecting behavioral data on a plurality of client devices operating within trusted execution environments (TEEs); executing a behavioral scoring model locally on each client device to generate enclave-bound history values; orchestrating federated training of the behavioral scoring model across the client devices, wherein each client generates a zero-knowledge proof attesting to compliance with a prescribed training protocol and the integrity of local model updates; aggregating verified model updates from selected clients without accessing raw behavioral data; immutably recording enclave-bound history values, model update attestations, and compliance proofs in a tamper-evident audit log; metering compute resources consumed by each client device and federated round; and issuing or redeeming IPS tokens to client devices or compute providers based on attributed compute value and compliance with sustainability-aware compute placement policies.

3. The system of claim 1, wherein the zero-knowledge proofs comprise proofs of compliance with data minimization, regulatory constraints, or auditability requirements.

4. The system of claim 1, wherein the federated learning coordinator performs verifiable client selection by requiring each client to submit a zero-knowledge proof of local model performance.

5. The system of claim 1, wherein the audit log subsystem utilizes a Merkle tree structure to enable scalable and cryptographically verifiable audit trails.

6. The system of claim 1, wherein the compute-value attribution engine supports dynamic pricing, microtransaction billing, and real-time attribution of compute value.

7. The system of claim 1, wherein the monetization module tokenizes intellectual property rights associated with the behavioral scoring model or audit logs as non-fungible tokens.

8. The system of claim 1, wherein the sustainability-aware compute placement policy dynamically schedules or migrates federated learning rounds to client devices or compute nodes with lower carbon intensity.

9. The system of claim 1, wherein the trusted execution environment comprises a hardware-based enclave supporting decentralized attestation using a physically unclonable function.

10. The system of claim 1, wherein the enclave-bound history values are cryptographically bound to a TEE attestation report and include a verifiable record of behavioral scoring model updates and inference results.

11. The system of claim 1, wherein the zero-knowledge proofs are generated using a zk-SNARK or zk-STARK framework.

12. The system of claim 1, wherein the compute-value attribution engine utilizes telemetry traces or OpenTelemetry-compatible mechanisms to capture fine-grained compute usage, agent decisions, and outcome metrics.

13. The system of claim 1, wherein IPS token issuance or redemption is conditioned on successful verification of zero-knowledge compliance proofs and sustainability metrics.

14. The system of claim 1, wherein the audit log subsystem supports selective disclosure enabling authorized third parties to verify compliance or audit trails without accessing underlying behavioral data or model parameters.

15. The method of claim 2, further comprising generating, by each client device, a zero-knowledge proof of compliance with data minimization, regulatory constraints, or auditability requirements.

16. The method of claim 2, further comprising performing verifiable client selection by requiring each client to submit a zero-knowledge proof of local model performance.

17. The method of claim 2, further comprising anchoring the audit log in a Merkle tree structure to enable scalable and cryptographically verifiable audit trails.

18. The method of claim 2, further comprising supporting dynamic pricing, microtransaction billing, and real-time attribution of compute value.

19. The method of claim 2, further comprising tokenizing intellectual property rights associated with the behavioral scoring model or audit logs as non-fungible tokens.

20. The method of claim 2, further comprising dynamically scheduling or migrating federated learning rounds to client devices or compute nodes with lower carbon intensity.
